(19) United States
(12) Patent Application Publication
(10) Pub. No.: US 2015/0008834 A1
(43) Pub. Date: Jan. 8, 2015

(54) LOSSLESS FORWARD VOLTAGE MATCHING NETWORK FOR LED DRIVERS

(71) Applicant: Huizhou Light Engine Limited, Huizhou City (CN)

(72) Inventors: WA HING LEUNG, Hong Kong (CN); Kam Wah Siu, Hong Kong (CN)

(73) Assignee: Huizhou Light Engine Limited, Huizhou City (CN)

(21) Appl. No.: 13/934,588

(22) Filed: Jul. 3, 2013

(51) Int. Cl. H05B 33/08

(52) U.S. Cl. CPC H05B 33/0842
USPC 315/187; 315/185 R

(57) ABSTRACT

A lossless LED forward voltage matching network connected between an AC source and a driver of an LED array, where the LED array is series connected and sequentially activates as the output voltage of the LED driver exceeds the respective forward voltages of the LED arrays. The matching network reduces the voltage from the AC source to approximate the total of the forward voltages of the series connected LED arrays to increase the efficiency of the device.

### TECHNICAL FIELD OF THE INVENTION

The present invention relates to power supplies for driving light emitting diode (“LED”) arrays. More specifically, to increase the efficiency of a series LED array that has a total forward voltage that is significantly lower than the voltage of an AC source, a lossless forward voltage matching network is provided between the AC source and the LED driver of the array. The lossless forward voltage matching network reduces the voltage of the AC source that is input into the LED driver to match the total forward voltage of the series LED array, resulting in a higher efficiency device.

### BACKGROUND OF THE INVENTION

There are two principal types of power supplies for LED lighting in the market—conventional line frequency power supplies and switching power supplies. The structure of line frequency or linear power supplies is relatively simple but the efficiency is low. Switching power supplies have a higher efficiency but have a tradeoff of more complex design and electromagnetic interference.

FIG. 1 shows a simple linear power supply driving an array of LEDs. LED apparatus 100 includes AC voltage source 102 with live and neutral terminals, with AC voltage source 102 producing a sinusoidal AC source voltage. The AC source voltage is applied to bridge rectifier 104 that converts the sinusoidal AC input voltage to a DC voltage with a ripple. The DC voltage is applied across LED arrays 106. Each LED array 106 has a forward voltage where the LED will begin to emit light when applied voltage exceeds the forward voltage. Linear current source 108 regulates the current flowing through LED arrays 106.

FIG. 2 shows the light output of LED apparatus 100 over time. As the AC voltage is rectified and applied to LED arrays 106, the LED arrays only turn on and provide light when the voltage applied across the LED arrays exceeds the sum of the forward voltages for the series-connected LED arrays. Since the rectified AC line voltage cycles from zero to a peak level and back to zero, the LED string turns off whenever the line voltage level falls below the forward voltage of the LED string. In addition, the LED current is discontinuous at the zero crossing of the AC voltage waveform. As shown in FIG. 2, the LED arrays provide illumination for only about 60% of the time, with the off-time being approximately 40%.

To retain the simple design of linear mode power supplies for LED arrays, while improving the efficiency and reducing light off-time, manufacturers have come up with the idea of powering only part of the LED string when the source voltage is not high enough to turn on the whole LED string. A more detailed explanation of the principals and operation of such devices is provided in U.S. Patent Application Publication No. 2012/0038615 to Leung et al., U.S. Patent Application Publication No. 2012/0038285 to Leung et al., and U.S. Provisional Patent Application No. 61/373,058, filed Aug. 12, 2010, all of which are incorporated herein by reference. These applications disclose various apparatus and methods for controlling the current sources depending on the number of LED arrays that are active.

A simplified exemplary circuit is shown in FIG. 3, which is a diagram that illustrates the concept of creating a variable forward voltage string during a half line cycle. As shown in FIG. 3, a string of LEDs may be divided into n LED arrays D1 to Dn, where n>1. Each LED array may include one or more LEDs. AC voltage 302, which may be AC mains, is rectified by bridge rectifier or LED driver 304 and is applied across LED arrays D1 to Dn. LED arrays D1 to Dn are powered by current sources I1 to In. Current sources I1 to In are controlled by comparator 306, which is connected across the output of LED driver 304. When AC voltage 302 crosses the forward voltage of LED array D1, comparator 306 causes current source I1 to become active and LED array d1 illuminates. As the voltage increases and exceeds each cumulative forward voltage of the LED arrays, the respective LED arrays and current sources will successively be turned on.

This is shown conceptually in FIG. 4. In FIG. 4, rectified voltage at the output of bridge rectifier 304 is shown as voltage curve 402. The illustration of LED arrays D1 to Dn and linear current sources I1 to In beneath voltage curve 402 shows the elements that are active at the particular voltage level at the particular time. Thus, when voltage curve 402 equals the voltage level determined by comparator 306 and exceeds the forward voltage of LED array D1, LED array D1 becomes active, as shown by illustration 404. As the voltage increases and exceeds the sum of the forward voltages of LED arrays D1 and D2, comparator 306 causes current source 12 to become active and LED arrays D1 and D2 become active, as shown by illustration 406. This continues until the maximum voltage is reached, as shown in the center of the graph where LED arrays D1 to Dn and current source In are active, as shown in illustration 408. As the applied voltage decreases, the LED arrays are successively deactivated. It should be noted that when n=1, the LED is just a single string and the driver is reduced to a single linear current source like the one shown in FIG. 1.

FIG. 5 shows the light output waveform of the LED driving method with the LED arrays divided into 5 arrays (i.e., n=5) with the forward voltage ratio of the arrays being 5:4:3:2:1. As can be seen from the waveform, the off-time is reduced to 10% using this configuration.

However, the forward voltage of the whole LED string must be close to the peak voltage value of the input voltage source to achieve good efficiency. This requires the forward voltage to be greater than 93% of the peak input voltage to achieve 90% efficiency. As an example, for a 220 Vac source with peak voltage of 311V, a 290V forward voltage LED string is needed to achieve 90% efficiency. If a lower forward voltage LED string is used, the efficiency will drop significantly. For example, a 150V forward voltage LED string powered by a 220V AC source can only achieve 60% efficiency. This limitation in LED forward voltage restricts the selection of LEDs.

Therefore, it is with respect to these considerations and others that the present invention has been made.

### BRIEF SUMMARY OF THE INVENTION

In light of the above, there exists a need to further improve the art.

In accordance with a first embodiment of the present invention, an AC power source provides AC current to an LED forward voltage matching network, which reduces the voltage level prior to feeding into an LED driver. The LED driver converts the AC current into a rectified signal that varies from zero to a peak value. The rectified signal is then applied to a series of LED arrays. As the output voltage exceeds the forward voltage of each LED array, the respective LED array turns on and is provided current through associated current sources. In one embodiment, the LED forward voltage matching network reduces the voltage level to a voltage level at or just above the forward voltage level of the series of LED arrays.

As exemplary embodiments, the LED forward voltage matching network may take the form of a series coupled inductor, a series coupled capacitor or a combination of a series coupled capacitor and inductor. In another embodiment of the invention, LED forward voltage matching network compensates for phase shift induced by the elements reducing the voltage of the AC power source.

In an exemplary embodiment, an LED array lighting apparatus comprising a plurality of LED arrays arranged in a serial path, with each LED array having a forward voltage; an LED driver coupled to and outputting a rectified voltage to the plurality of LED arrays; one or more current sources coupled between the LED arrays and configured to supply current to each respective LED array as the output voltage of the LED driver exceeds the forward voltage of the respective LED array in the serial path; and an LED forward voltage matching network coupled to the LED driver for reducing the voltage provided by a voltage supply source, thereby reducing the difference between the LED driver output and a sum of the forward voltages of all of the plurality of LED arrays in the serial path.

In a further exemplary embodiment, the LED forward voltage matching network reduces the voltage provided by the voltage supply source to the LED driver so that the sum of the forward voltages of the plurality of LED arrays in the serial path is at least 93% of the peak input voltage to the LED driver.

In a further exemplary embodiment, the LED forward voltage matching network contains at least one capacitor connected in series with at least one inductor between the input and output of the LED forward voltage matching network.

In a further exemplary embodiment, the LED forward voltage matching network contains at least one additional capacitor connected in series with at least one additional inductor between the inputs of the LED forward matching network to compensate for phase shift of the drawn current.

In a further exemplary embodiment, the LED forward voltage matching network contains at least one capacitor connected in series between the input and output of the LED forward matching network.

In a further exemplary embodiment, the LED forward voltage matching network contains at least one inductor connected between the inputs of the LED forward matching network to compensate for phase shift of the drawn current

In a further exemplary embodiment, the LED forward voltage matching network contains at least one inductor connected in series between the input and output of the LED forward matching network.

In a further exemplary embodiment, the LED forward voltage matching network contains at least one capacitor connected between the inputs of the LED forward matching network to compensate for phase shift of the drawn current.

In another exemplary embodiment, a method of providing power to an LED array lighting apparatus comprising reducing the voltage of an AC power supply for input into an LED driver; rectifying in the LED driver the reduced voltage of the AC power supply; applying the rectified voltage to a plurality of LED arrays arranged in a serial path, each LED array having a forward voltage; activating one or more current sources connected between each LED array as the output voltage of the LED driver exceeds the forward voltage of the respective LED array in the serial path; and wherein the reduced voltage of the AC power supply to the LED driver is slightly greater than the sum of the forward voltages for the plurality of LED arrays.

In a further exemplary embodiment, the LED forward voltage matching network reduces the voltage provided by the voltage supply source to the LED Driver so that the sum of the forward voltages of all of the plurality of LED arrays in the serial path is at least 93% of the peak input voltage to the LED driver.

In a further exemplary embodiment, the LED forward voltage matching network reduces the voltage through at least one capacitor connected in series with at least one inductor between one of the inputs and one of the outputs of the LED forward matching network.

In a further exemplary embodiment, the LED forward voltage matching network compensates for phase shift through at least one additional capacitor connected in series with at least one additional inductor between the inputs of the LED forward matching network.

In another exemplary embodiment, an LED array lighting apparatus comprising a plurality of LED arrays arranged in a serial path, each LED array having a forward voltage; an LED driver coupled to and providing an output voltage to the plurality of LED arrays; a means for activating each of the LED arrays as the output voltage of the LED driver exceeds the forward voltage of the respective LED array in the serial path; and a means for reducing the voltage provided by a voltage supply source to the LED driver.

In a further exemplary embodiment, the LED array lighting apparatus further comprising a means for compensating for phase shift caused by the means for reducing the voltage provided by a voltage supply source to the LED driver.

### BRIEF DESCRIPTION OF THE DRAWINGS

The figures are for illustration purposes only and are not necessarily drawn to scale. However, the invention itself may best be understood by reference to the detailed description which follows when taken in conjunction with the accompanying drawings in which:

FIG. 1 is a simple linear power supply driving an array of LEDs;

FIG. 2 is the light output of the apparatus shown in FIG. 1 over time;

FIG. 3 is a diagram that illustrates the concept of creating a variable forward voltage string during a half line cycle;

FIG. 4 is a conceptual rendering showing the rectified voltage at the output of bridge rectifier being applied to the LED arrays with the active LED arrays at the particular voltages and at the particular times illustrated below the curve;

FIG. 5 shows the light output waveform of the LED driving method shown in FIG. 4 with the LED arrays divided into 5 arrays;

FIG. 6 shows one embodiment of the connection of the matching network of the present invention to the LED driver;

FIG. 7 is a diagram of one embodiment of the lossless LED forward voltage matching network presented in its general form;

FIGS. 8a to 8d show other embodiments of the lossless LED forward voltage matching network; and

FIG. 9 shows the input, output voltage and current waveforms of the matching network.

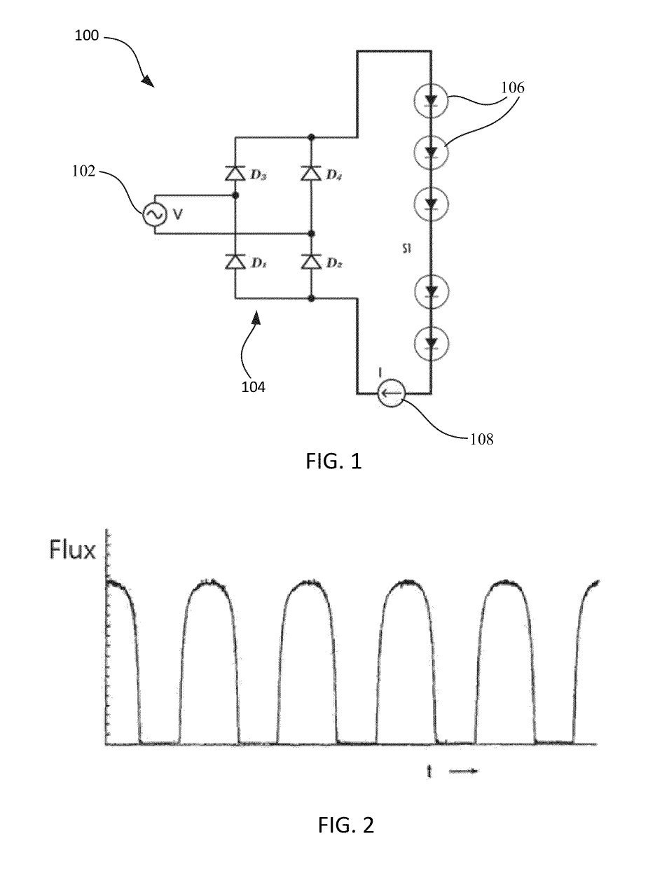

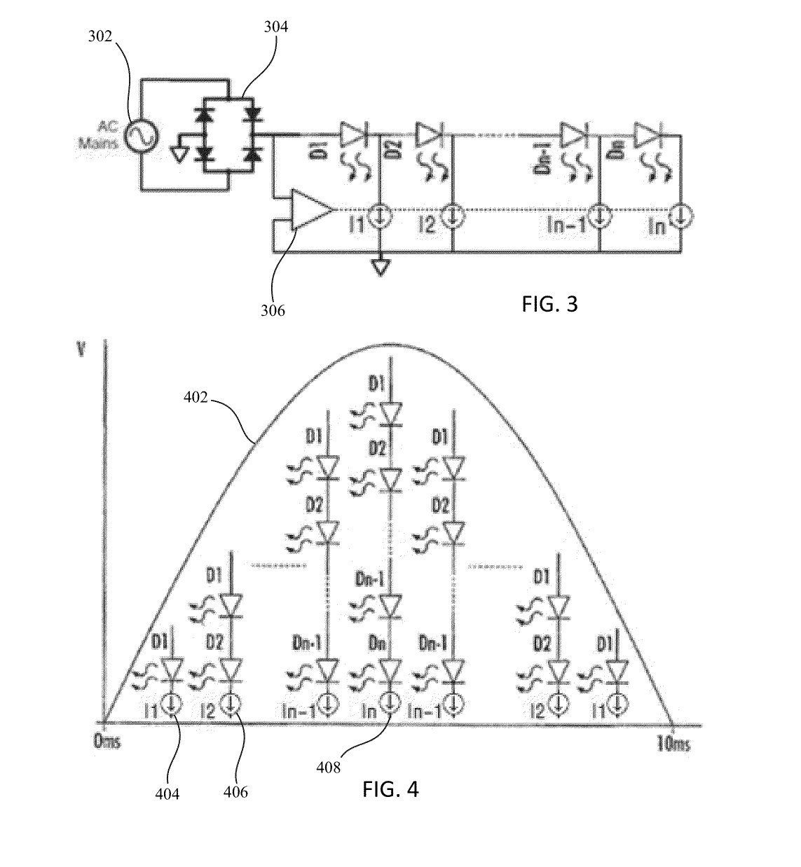

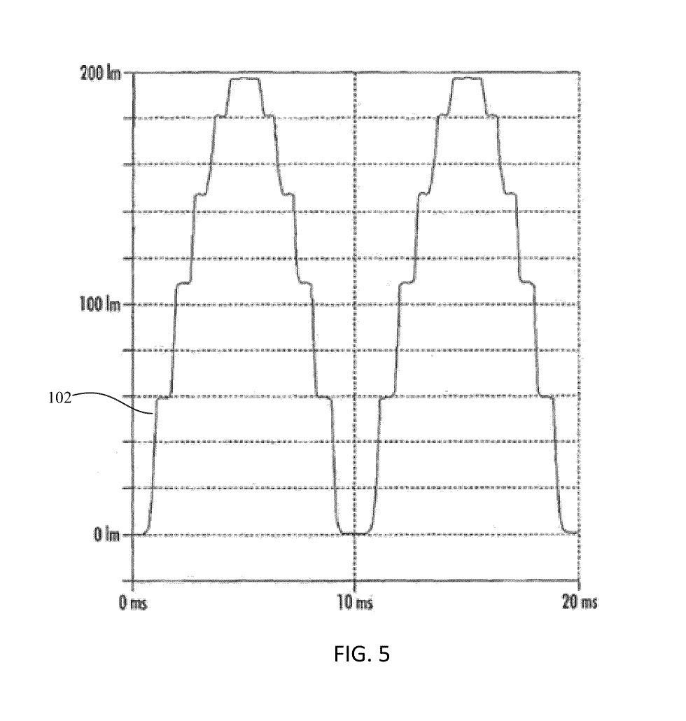

### DETAILED DESCRIPTION OF THE INVENTION

Various embodiments will now be described with reference to the accompanying drawings, which form a part of the description, and which show, by way of illustration, specific embodiments. However, this invention may be embodied in many different forms and should not be construed as limited to the specific embodiments set forth herein. Rather, these embodiments are provided so that this disclosure will be thorough and complete, and will fully convey the scope of the invention to those skilled in the art. As described below, various embodiments of the invention may be readily combined without departing from the scope or spirit of the invention.

The following briefly describes the embodiments of the invention to provide a basic understanding of some aspects of the invention. It is not intended to identify key or critical elements, or to delineate or otherwise narrow the scope of the invention. Its purpose is merely to present some concepts in a simplified form.

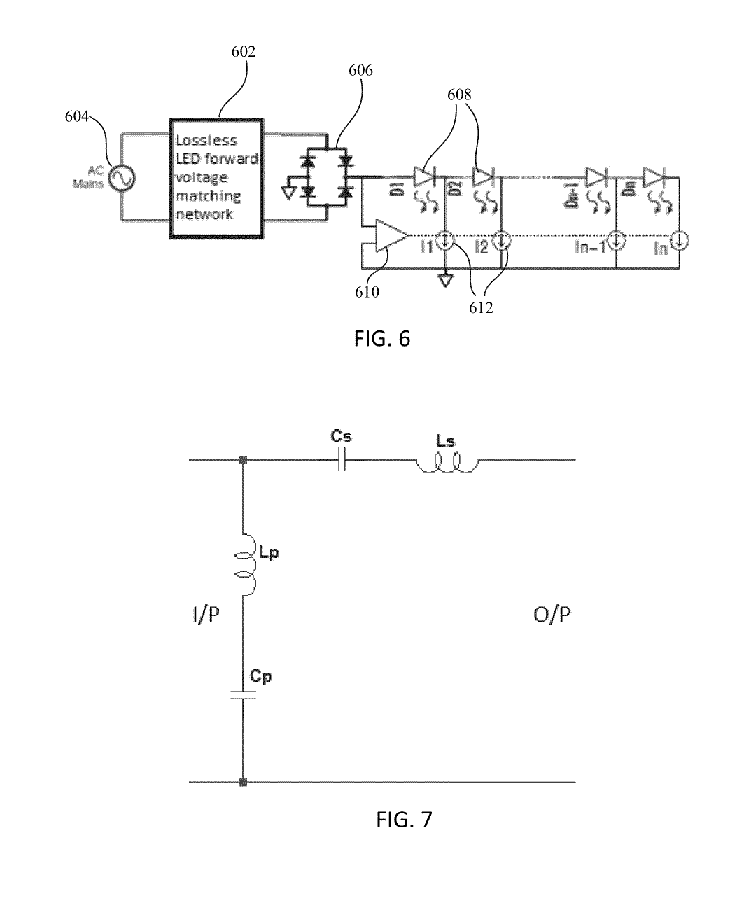

The general location of the lossless LED forward voltage matching network is shown in FIG. 6. Matching network 602 connects between AC voltage source 604 and LED driver or bridge rectifier 606. Matching network 602 takes the AC source voltage as input and outputs a reduced amplitude AC voltage to LED driver 606. LED driver 606 provides a rectified signal to series connected LED arrays 608, which sequentially become active as the output voltage of LED driver 606 exceeds the respective forward voltages of the LED arrays. Comparator 610 activates respective current sources 612 based on the output voltage of LED driver 606 to provide driving current for the LED arrays. Although a general embodiment of one method of sequentially activating LED arrays is provided herein, any of the methodologies provided herein and in U.S. Patent Application Publication No. 2012/0038615 to Leung et al. may be used for activating and powering the LED array configuration attached to LED driver 606.

FIG. 7 is a diagram of one embodiment of a lossless LED forward voltage matching network. In this embodiment, capacitor Cs and inductor Ls are provided in series between the input and output of the matching network. The value of the capacitor and inductor are chosen based on the ratio of the input voltage to the required output voltage, which output voltage depends on the sum of the forward voltages of the LED arrays, so as to lower the output voltage supplied to the LED driver. It is assumed that the impedance of the LED driver is approximately resistive and the total series impedance of Cs and Ls, which is represented by Xs, is purely reactive. An input voltage Vi at frequency F is applied to the network to produce an output voltage Vo to drive the LED driver. The LED driver draws an average current of Id, which is also the current through Cs and Ls. The relationship of between Vi and Vo can be written as

Vi²=Id²Xs²+Vo² (1)

with

Xs=1/(2πF Cs)−2πF Ls (2).

Suppose a 20 mA (Id) LED string of total forward voltage of 150V is powered by a 220 Vac (Vi)/50 Hz (F) mains source, it is desirable to have the input voltage reduced to 120 Vac (Vo) by the lossless LED forward voltage matching network in order to achieve good efficiency. In this case, Xs can be calculated as 9220 ohm. By assigning a practical value of 0.33 uF for Cs, Ls can be calculated as 1335 mH. By lowering the output voltage supplied to the LED driver, a lower voltage is provided to LED arrays 608 which, when the voltage is chosen appropriately, overcomes the low efficiency problem when driving low forward voltage LEDs with linear LED drivers. The addition of Cs and Ls introduces a phase shift (leading or lagging) to the current drawn from AC source 604. Therefore, in another embodiment, inductor Lp and capacitor Cp are provided to compensate for this phase shift.

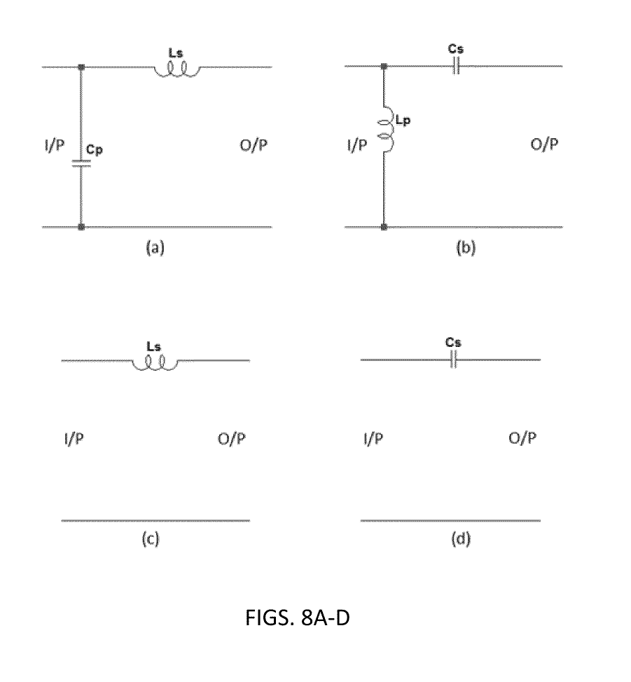

Other embodiments of the matching network are shown in FIGS. 8(a)-8(d). Matching network 602 may be reduced to its simplest form which uses a single series-connected inductor Ls or series-connected capacitor Cs.

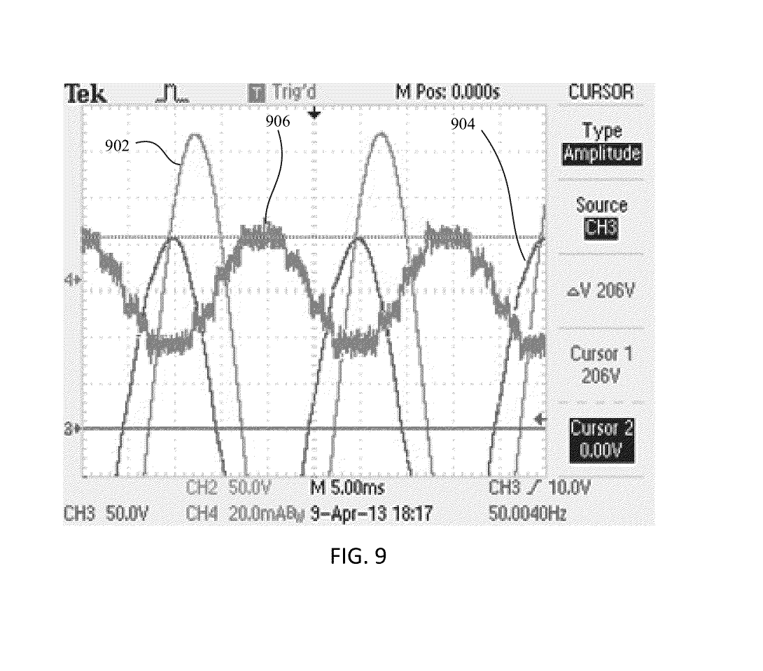

A specific example of the efficiency gains of the matching network shown in FIG. 8(d) is demonstrated by the graph of FIG. 9. FIG. 9 shows input voltage 902 from AC source 604 (using the FIG. 6 configuration), output voltage 904 from matching network 602 and current waveform 906 of matching network 602, using the matching current network of FIG. 8(d). The value for Cs is 0.33 uF. In this instance, the input voltage is 220 Vac and output voltage is 145 Vac. The LED forward voltage in this particular instance is 150V. The output voltage, which is much closer to the LED forward voltage (150V) than 220 Vac, powers the linear LED driver to work at a higher efficiency operating condition. The efficiency of a 150V forward voltage LED string powered by a 220 Vac source in which the voltage is reduced by the matching network of the present invention to 145 Vac can be increased from 59% to 80%. Consider a half line cycle of a 220 Vac source, the peak voltage is 311V. LED current will flow when the phase angle is between 29° (0.51 rad) and 151° (2.64 rad) where the line voltage is above 150V. Assume the LED current is constant and is represented by I, the power drawn by the LED driver is

$$\frac{1}{π} {\int }_{0.51`}^{2.64} I \cdot 311 sin θ d θ = 173 I ,$$

and the power drawn by LED is

$$\frac{1}{π} {\int }_{0.51`}^{2.64} 150 I d θ = 102 I .$$

Efficiency with 220 Vac input is 102/173=59%.
For 145 Vac source, the peak voltage is 205V. LED current will flow when the phase angle is between 47° (0.82 rad) and 133° (2.32 rad) where the line voltage is above 150V. The power drawn by the LED driver is

$$\frac{1}{π} {\int }_{0.82}^{2.32} I \cdot 205 sin θ d θ = 89 I ,$$

and the power drawn by LED is

$$\frac{1}{π} {\int }_{0.82}^{2.32} 150 I d θ = 71.6 I .$$

Efficiency with 145 Vac input is 71.6/89=80%.

Although other modifications and changes may be suggested by those skilled in the art, it is the intention of the inventors to embody within the patent warranted hereon all changes and modifications that reasonably and properly come within the scope of their contribution to the art.

What is claimed is:

1. An LED array lighting apparatus comprising:
a plurality of LED arrays arranged in a serial path, with each LED array having a forward voltage;
an LED driver coupled to and outputting a rectified voltage to the plurality of LED arrays;
one or more current sources coupled between the LED arrays and configured to supply current to each respective LED array as the output voltage of the LED driver exceeds the forward voltage of the respective LED array in the serial path; and
an LED forward voltage matching network coupled to the LED driver for reducing the voltage provided by a voltage supply source, thereby reducing the difference between the LED driver output and a sum of the forward voltages of all of the plurality of LED arrays in the serial path.

2. The lighting apparatus of claim 1, wherein the LED forward voltage matching network reduces the voltage provided by the voltage supply source to the LED driver so that the sum of the forward voltages of the plurality of LED arrays in the serial path is at least 93% of the peak input voltage to the LED driver.

3. The lighting apparatus of claim 1, wherein the LED forward voltage matching network contains at least one capacitor connected in series with at least one inductor between the input and output of the LED forward voltage matching network.

4. The lighting apparatus of claim 3, wherein the LED forward voltage matching network contains at least one additional capacitor connected in series with at least one additional inductor between the inputs of the LED forward matching network to compensate for phase shift of the drawn current.

5. The lighting apparatus of claim 1, wherein the LED forward voltage matching network contains at least one capacitor connected in series between the input and output of the LED forward matching network.

6. The lighting apparatus of claim 5, wherein the LED forward voltage matching network contains at least one inductor connected between the inputs of the LED forward matching network to compensate for phase shift of the drawn current.

7. The lighting apparatus of claim 1, wherein the LED forward voltage matching network contains at least one inductor connected in series between the input and output of the LED forward matching network.

8. The lighting apparatus of claim 7, wherein the LED forward voltage matching network contains at least one capacitor connected between the inputs of the LED forward matching network to compensate for phase shift of the drawn current.

9. A method of providing power to an LED array lighting apparatus comprising:
reducing the voltage of an AC power supply for input into an LED driver;
rectifying in the LED driver the reduced voltage of the AC power supply;
applying the rectified voltage to a plurality of LED arrays arranged in a serial path, each LED array having a forward voltage;
activating one or more current sources connected between each LED array as the output voltage of the LED driver exceeds the forward voltage of the respective LED array in the serial path; and
wherein the reduced voltage of the AC power supply to the LED driver is slightly greater than the sum of the forward voltages for the plurality of LED arrays.

10. The method of claim 9, wherein the LED forward voltage matching network reduces the voltage provided by the voltage supply source to the LED Driver so that the sum of the forward voltages of all of the plurality of LED arrays in the serial path is at least 93% of the peak input voltage to the LED driver.

11. The method of claim 9, wherein the LED forward voltage matching network reduces the voltage through at least one capacitor connected in series with at least one inductor between one of the inputs and one of the outputs of the LED forward matching network.

12. The method of claim 3, wherein the LED forward voltage matching network compensates for phase shift through at least one additional capacitor connected in series with at least one additional inductor between the inputs of the LED forward matching network.

13. An LED array lighting apparatus comprising:
a plurality of LED arrays arranged in a serial path, each LED array having a forward voltage;
an LED driver coupled to and providing an output voltage to the plurality of LED arrays;
a means for activating each of the LED arrays as the output voltage of the LED driver exceeds the forward voltage of the respective LED array in the serial path; and
a means for reducing the voltage provided by a voltage supply source to the LED driver.

14. The LED array lighting apparatus of claim 13, further comprising:
a means for compensating for phase shift caused by the means for reducing the voltage provided by a voltage supply source to the LED driver.
